(19) United States
(12) Patent Application Publication
(10) Pub. No.: US 2010/0119786 A1
(43) Pub. Date: May 13, 2010

(54) IMAGE RECORDING METHOD, RECORDING MATERIAL, AND IMAGE RECORDING APPARATUS

(75) Inventors: Takayoshi KAGATA, Shiojiri-shi (JP); Tsuyoshi SANO, Shiojiri-shi (JP)

Correspondence Address: LADAS & PARRY, 26 West 61st Street, New York, NY, 10023, US

(73) Assignee: SEIKO EPSON CORPORATION

(21) Appl. No.: 12/614,569

(22) Filed: Nov. 9, 2009

(30) Foreign Application Priority Data
Nov. 10, 2008 (JP) 2008-288085

(51) Int. Cl. B32B 3/10; B05D 1/36; B05D 5/06; B41J 2/015

(52) U.S. Cl. 428/195.1; 427/402; 427/407.1; 427/419.1; 427/265; 347/20

(57) ABSTRACT

An image recording method includes forming a color image on a recording medium using a color ink composition containing a color colorant; and forming a white layer on the color image using a white ink composition containing a white colorant. In the image recording method described above, the white layer is formed on the color image so that an equivalent ratio of the white colorant to the color colorant is set to 1 to 1,000:1 to form a pastel color image.

### BACKGROUND

1. Technical Field

The present invention relates to an image recording method for reproducing a pastel color. In addition, the invention also relates to a recording material obtained by the image recording method and an image recording apparatus using the image recording method.

2. Related Art

Heretofore, color reproduction of a pastel color has been performed by various methods. The pastel color is not a clearly defined color, such as an elementary color, and is an intermediate color located in a region in which the luminance is high and the saturation is low.

As a method for reproducing this pastel color, for example, in writing instruments, such as a ballpoint pen, reproduction of a pastel color is performed using a liquid composition obtained by mixing a white colorant, such as hollow resin particles or titanium oxide, and a color colorant (for example, see JP-A-03-157664, JP-A-03-277669, and JP-A-09-316382). In addition, in image formation by an ink jet recording method or the like, reproduction is performed by jetting color ink compositions, such as cyan (C), magenta (M), yellow (Y), and black (K), to a recording medium without using a white ink composition so as to obtain a color having a high luminance and a low saturation.

Incidentally, as one color model that conceptually explains the color space, the CIE/L*a*b* color coordinate system has been known. Among the three parameters (L*, a*, b*) of the CIE/L*a*b* color coordinate system, L* indicates the luminance (brightness) of color, and a* and b* each indicate the chromaticity showing the hue and the saturation. In this color coordinate system, L*=0 indicates black, and L*=100 indicates white. In addition, a* indicates a position between red and green, a negative a* value indicates green, and a positive a* value indicates red. Furthermore, b* indicates a position between yellow and blue, a negative b* value indicates blue, and a positive b* value indicates yellow. Since the L*a*b* color model is a three-dimensional system, the color space is represented by a three-dimensional space, and the luminance is shown on the vertical axis. However, when image formation is performed by an ink jet recording method using only color ink compositions such as cyan (C), magenta (M), yellow (Y), and black (K), since the color ink compositions must be thinly coated on a recording medium in order to decrease the saturation, there is a pastel color that cannot be reproduced, in particular, in a high luminance region in which L*≧80 holds.

In addition, in JP-A-2005-125690, an image recording method has been disclosed in which when an image formed using color ink compositions has not a desired concentration, the concentration is controlled by jetting a white ink on the image to perform concentration correction. However, an object of the invention disclosed in JP-A-2005-125690 is to remove individual difference in color caused between recording apparatuses and to perform a strict color control from a low to a high concentration portion; hence, when an image has a lower concentration than a desired concentration, a small amount of a white ink is jetted on the image in order to increase the luminance thereof, and this technique is not intended to reproduce a pastel color.

### SUMMARY

An advantage of some aspects of the invention is to provide a novel image recording method for reproducing a pastel color, and in particular, to provide an image recording method suitable to an ink jet recording system.

In accordance with a first aspect of the invention, there is provided an image recording method comprising the steps of: forming a color image on a recording medium using a color ink composition containing a color colorant; and forming a white layer on the color image using a white ink composition containing a white colorant. In the image recording method described above, the white layer is formed on the color image so that an equivalent ratio of the white colorant to the color colorant is set to 1 to 1,000:1 to form a pastel color image.

According to the image recording method of the first aspect, in the CIE/L*a*b* color space, the pastel color may be a color in which L*≧60, −50≦a*≦50, and −50≦b*≦50 hold.

According to the image recording method of the first aspect, the white colorant may be at least one selected from the group consisting of a metal compound and hollow resin particles.

According to the image recording method of the first aspect, the color colorant may be a pigment colorant or a dye colorant.

The image recording method according to the first aspect of the invention may be performed by an ink jet recording system.

According to a second aspect of the invention, there is provided a recording material obtained by the image recording method according to the first aspect of the invention.

According to a third aspect of the invention, there is provided an image recording apparatus using the image recording method according to the first aspect of the invention.

According to the image recording method of the invention, a pastel color which has been difficult to be reproduced, particularly, by an ink jet recording system can be reproduced.

### BRIEF DESCRIPTION OF THE DRAWINGS

The invention will be described with reference to the accompanying drawings, wherein like numbers reference like elements.

FIG. 1 shows comparisons each between a color reproducing region of a pastel color reproducible by color printing using a pigment color ink composition and a color reproducing region obtained by performing white printing (using hollow resin particles as a white colorant) at a duty of 80% or 100% after the color printing.

FIG. 2 shows comparisons each between a color reproducing region of a pastel color reproducible by color printing using a pigment color ink composition and a color reproducing region obtained by performing white printing (using titanium dioxide as a white colorant) at a duty of 80% after the color printing.

FIG. 3 shows comparisons each between a color reproducing region of a pastel color reproducible by color printing using a dye color ink composition and a color reproducing region obtained by performing white printing (using hollow resin particles as a white colorant) at a duty of 80% after the color printing.

FIG. 4 shows comparisons each between a color reproducing region of a pastel color reproducible by color printing using a dye color ink composition and a color reproducing region obtained by performing white printing (using titanium dioxide as a white colorant) at a duty of 80% after the color printing.

### DESCRIPTION OF EXEMPLARY EMBODIMENTS

An image recording method of the invention relates to a novel image recording method for reproducing a pastel color. The image recording method of the invention is an image recording method in which after a color image is formed on a recording medium using a color ink composition which contains a color colorant, a white layer is formed on the color image using a white ink composition which contains a white colorant, and in this method, the white layer is formed on the color image so that an equivalent ratio of the white colorant to the color colorant is set to 1 to 1,000:1 to form a pastel color image.

In addition, in the invention, the pastel color indicates an intermediate color present in a region of the CIE/L*a*b* color space in which the luminance is high and the saturation is low and is preferably a color present in a region in which L*≧60, −50≦a*≦50, and −50≦b*≦50 hold. In addition, the mass ratio between the color colorant and the white colorant is obtained based on each colorant amount (on a mass basis) per unit area when the image formation is performed on the recording medium. Hereinafter, the image recording method of the invention will be described in detail.

White Ink Composition

A white ink composition of the invention preferably contains at least one of a metal compound and hollow resin particles as a white colorant and a resin component fixing the colorant.

1. Metal Compound and Hollow Resin Particles

As the metal compound of the invention, for example, a metal oxide which has been used as a white pigment, barium sulfate, and calcium carbonate may be mentioned. Although the metal oxide is not particularly limited, for example, titanium dioxide, zinc oxide, silica, alumina, and magnesium oxide may be mentioned. As the metal compound of the invention, titanium dioxide and alumina are preferable.

The content of the metal compound is preferably 1.0 to 20.0 mass percent and more preferably 5.0 to 10.0 mass percent with respect to the total mass of the ink composition. When the content of the metal compound is more than 20.0 mass percent, the reliability may be degraded in some cases due to clogging of an ink jet recording head or the like. On the other hand, when the content is less than 1.0 mass percent, the color concentration, such as the degree of whiteness, tends to be deficient.

The average particle diameter (outside diameter) of the metal compound is preferably 30 to 600 nm and more preferably 200 to 400 nm. When the outside diameter is more than 600 nm, since the particles may precipitate, the dispersing stability may be degraded, and the reliability may also be degraded due to clogging of an ink jet recording head or the like. On the other hand, when the outside diameter is less than 30 nm, the degree of whiteness tends to be deficient.

The average particle diameter of the metal compound can be measured by a particle size distribution measurement apparatus using a laser diffraction scattering method as a measurement principle. As the laser diffraction particle size distribution measurement apparatus, for example, a particle size distribution meter (such as “Microtrack UPA” manufactured by Nikkiso Co., Ltd.) using a dynamic light scattering method as a measurement principle may be used.

As the hollow resin particles of the invention, particles which have hollows therein and which have outside shells formed from a liquid-permeable resin are preferable. By the structure described above, when the hollow resin particles are present in an aqueous ink composition, the inside hollows are filled with an aqueous medium. Since the particles filled with an aqueous medium has an approximately equivalent specific gravity to that of the outside aqueous medium, the particles may not precipitate in the aqueous ink composition, so that the dispersing stability can be maintained. As a result, the storage stability and ejection stability of the ink composition can be improved.

In addition, when the white ink composition of the invention is ejected to a recording medium, such as paper, the aqueous medium inside the particles are removed in drying, so that the hollows again obtained inside the particles. Since air is contained inside the particles, the particles each form a resin layer and an air layer having a refractive index different from that of the resin layer so as to effectively scatter incident light, and hence, a white color is shown.

The hollow resin particles used in the invention are not particularly limited, and known particles may be used. For example, hollow resin particles disclosed in U.S. Pat. No. 4,880,465 and Japanese Patent No. 3,562,754 are preferably used.

The average particle diameter (outside diameter) of the hollow resin particles is preferably 0.2 to 1.0 μm and more preferably 0.4 to 0.8 μm. When the outside diameter is more than 1.0 μm, since the particles may precipitate, the dispersing stability may be degraded, and for example, an ink jet recording head is clogged, so that the reliability may be degraded. On the other hand, when the outside diameter is less than 0.2 μm, the color concentration, such as the degree of whiteness, tends to be deficient. In addition, the inside diameter is appropriately about 0.1 to 0.8 μm.

The average particle diameter of the hollow resin particles can be measured by a particle size distribution measurement apparatus using a laser diffraction scattering method as a measurement principle. As the laser diffraction particle size distribution measurement apparatus, for example, a particle size distribution meter (such as “Microtrack UPA” manufactured by Nikkiso Co., Ltd.) using a dynamic light scattering method as a measurement principle may be used.

The content (solid component) of the hollow resin particles is preferably 5 to 20 mass percent and more preferably 8 to 15 mass percent with respect to the total mass of the ink composition. When the content (solid component) of the hollow resin particles is more than 20 mass percent, for example, an ink jet recording head is clogged, so that the reliability may be degraded. On the other hand, when the content is less than 5 mass percent, the degree of whiteness tends to be deficient.

A method for preparing the hollow resin particles is not particularly limited, and a know method may be used. As the method for preparing hollow resin particles, for example, a so-called emulsion polymerization method may be used in which a vinyl monomer, a surfactant, a polymerization initiator, and an aqueous dispersant are heated and stirred in a nitrogen atmosphere to form a hollow resin particle emulsion.

As the vinyl monomer, nonionic monoethylene unsaturated monomers, such as styrene, vinyl toluene, ethylene, vinyl acetate, vinyl chloride, vinylidene chloride, acrylonitrile, (meth)acrylamide, and (meth)acrylic acid ester, may be mentioned. As the (meth)acrylic acid ester, for example, methyl acrylate, methyl methacrylate, ethyl (meth)acrylate, butyl (meth)acrylate, 2-hydroxyethyl methacrylate, 2-ethylhexyl (meth)acrylate, benzyl (meth)acrylate, lauryl (meth)acrylate, oleyl (meth)acrylate, palmityl (meth)acrylate, and stearyl (meth)acrylate may be mentioned.

In addition, as the vinyl monomer, bifunctional vinyl monomers may also be used. As the bifunctional vinyl monomers, for example, divinyl benzene, allyl methacrylate, ethylene glycol dimethacrylate, 1,3-butanediol dimethacrylate, diethylene glycol dimethacrylate, and trimethylolpropane trimethacrylate may be mentioned. When highly cross linking is performed by copolymerizing the monofunctional vinyl monomer and the bifunctional vinyl monomer, hollow resin particles having properties such as heat resistance, solvent resistance, and solvent dispersibility as well the light scattering properties can be obtained.

As the surfactant, any surfactants each forming molecular aggregates, such as micelles, in water may be used, and for example, an anionic surfactant, a nonionic surfactant, a cationic surfactant, and an amphoteric surfactant may be mentioned.

As the polymerization initiator, a known compound which is soluble in water may be used, and for example, hydrogen peroxide and potassium persulfate may be mentioned.

As the aqueous dispersant, for example, water and water containing a hydrophilic organic solvent may be mentioned.

2. Fixing Resin

The white ink composition of the invention preferably contains a resin fixing the hollow resin particles. As this fixing resin, for example, an acrylic resin (such as Almatex (manufactured by Mitsui Chemicals Inc.)) and a urethane resin (such as WBR-022U (manufactured by Taisei Fine Chemical Co., Ltd.) may be mentioned.

The content of the fixing resin described above is preferably 0.5 to 10 mass percent and more preferably 0.5 to 3.0 mass percent with respect to the total mass of the ink composition.

3. Permeable Organic Solvent

The white ink composition of the invention preferably contains at least one selected from an alkanediol and a glycol ether. The alkanediol and the glycol ether can increase the wettability of an ink to a recording surface of a recording medium or the like, so that the permeability of the ink can be improved.

The alkanediol is preferably a 1,2-alkanediol having 4 to 8 carbon atoms, such as 1,2-butanediol, 1,2-pentanediol, 1,2-hexanediol, 1,2-heptanediol, or 1,2-octanediol. Among those mentioned above, 1,2-hexanediol, 1,2-heptanediol, and 1,2-octanediol, each having 6 to 8 carbon atoms, are more preferable since the permeability thereof to a recording medium is particularly high.

As the glycol ether, for example, a lower alkyl ether of a polyol, such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, or tripropylene glycol monomethyl ether. Among those mentioned above, by using triethylene glycol monobutyl ether, a superior recording quality can be obtained.

The content of the at least one selected from the group consisting of an alkanediol and a glycol ether is preferably 1 to 20 mass percent and more preferably 1 to 10 mass percent with respect to the total mass of the white ink composition.

4. Surfactant

The white ink composition of the invention preferably contains an acetylene glycol-based surfactant or a polysiloxane-based surfactant. The acetylene glycol-based surfactant or the polysiloxane-based surfactant can increase the wettability of an ink to a recording surface of a recording medium or the like, so that the permeability of the ink can be increased.

As the acetylene glycol-based surfactant, for example, 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-hexyn-3-ol may be mentioned. In addition, a commercially available acetylene glycol-based surfactant may also be used, and for example, Olfin E1010, STG, and Y (manufactured by Nisshin Chemical Industry Co., Ltd.) and Surfynol 104, 82, 465, 485, and TG (manufactured by Air Products and Chemicals Inc.) may be mentioned.

As the polysiloxane-based surfactant, for example, a commercially available surfactant may be used, and for example, BYK-347 and BYK-348 (manufactured by BYK-Chemie, Japan) may be mentioned.

Furthermore, the white ink composition of the invention may contain another surfactant, such as an anionic surfactant, a nonionic surfactant, or an amphoteric surfactant.

The content of the surfactant is preferably 0.01 to 5 mass percent and more preferably 0.1 to 0.5 mass percent with respect to the total mass of the white ink composition.

5. Tertiary Amine

The white ink composition of the invention preferably contains a tertiary amine. The tertiary amine functions as a pH adjuster and can easily adjust the pH of the white ink composition.

As the tertiary amine, for example, triethanolamine may be mentioned.

The content of the above tertiary amine is preferably 0.01 to 10 mass percent and more preferably 0.1 to 2 mass percent with respect to the total mass of the white ink composition.

6. Solvent and Additives

The white ink composition of the invention usually contains water as a solvent. As the water, pure water or ultrapure water, such as ion-exchanged water, ultrafiltration water, reverse osmosis water, or distilled water, is preferably used. In particular, water prepared by sterilizing the above-mentioned water with ultraviolet irradiation or addition of hydrogen peroxide is preferable since the growth of fungi and bacteria can be suppressed for a long period of time.

The white ink composition of the invention may contain additives whenever necessary, and for example, a fixing agent such as water-soluble rosin, a fungicide or antiseptic such as sodium benzoate, an antioxidant or ultraviolet absorber such as an allophanate, a chelating agent, and an oxygen absorbent may be used. These additives may be used alone, and of course, at least two thereof may be used in combination.

7. Preparation Method

The white ink composition of the invention may be prepared by a known apparatus, such as a ball mill, a sand mill, an attritor, a basket mill, or a roll mill, in a manner similar to that for a related pigment ink. In the preparation, coarse particles are preferably removed using a membrane filter, a mesh filter, or the like.

Color Ink Composition

As the color ink composition of the invention, any color ink composition may be used as long as it contains a color colorant, and a color ink composition exhibiting color other than white is preferable. The color ink composition of the invention is not particularly limited, and a commercially available color ink composition may also be used.

As the color colorant, either a pigment colorant or a dye colorant may be used, and for example, color ink compositions disclosed in JP-A-2003-192963, JP-A-2005-23253, JP-A-9-3380, and JP-A-2004-51776 may be preferably used.

In addition, the “color” of the invention does not indicate a specific color region but indicates all regions which are generally believed to have color. That is, in the “L*a*b* coordinate system, the “color” of the invention indicates a color located at coordinates other than those in which L*=100, a*=0, and b*=0 (ideal white) hold.

Image Recording Method

The image recording method of the invention is an image recording method in which after a color image is formed on a recording medium using a color ink composition containing a color colorant, a white layer is formed on the color image using a white ink composition containing a white colorant, and the white layer is formed on the color image so that an equivalent ratio of the white colorant to the color colorant is set to 1 to 1,000:1 to form a pastel color image. With respect to one equivalent of the color colorant, 10 to 500 equivalents of the white colorant is preferable, and 100 to 300 equivalents thereof is more preferable. The mass ratio between the color colorant and the white colorant is obtained based on each colorant amount (on a mass basis) per unit area when the image formation is performed on the recording medium. When the mass of the white colorant with respect to the color colorant used for image recording is adjusted, an arbitrary pastel color can be reproduced.

The methods for forming a color image and a white color layer are not particularly limited, and for example, a relief printing system, an intaglio printing system, a planographic printing system, a screen printing system, an electrophotographic recording system, a thermal transfer recording system, and an ink jet recording system may be mentioned. Among those mentioned above, a recording method by an ink jet recording system is particularly preferable.

As the ink jet recording system, there are various ink jet recording systems. As the ink jet recording system, for example, a thermal jet-type ink jet system, a piezoelectric type ink jet system, a continuous ink jet system, a roller application system, and a spray application system may be mentioned.

The color image and the white layer may be formed by applying the respective ink compositions to various recording media. As the recording media, for example, paper, heavy paper, fiber products, sheets, films, plastics, glass, and ceramics may be mentioned.

Recording Material and Recording Apparatus

The invention is able to provide a recording material on which a pastel color image, which has been difficult to be reproduced, is recorded by the image recording method described above.

In addition, the invention is also able to provide an image recording apparatus which uses the above image recording method. By the image recording apparatus described above, a pastel color image, which has been difficult to be reproduced, can be formed.

### EXAMPLES

Hereinafter, the invention will be described in more detail with reference to Examples; however, the invention is not limited thereto.

White Ink Composition

First, in accordance with compositions shown in Table 1, white ink compositions (ink 1 and ink 2) each containing white hollow resin particles or a metal compound as a colorant were prepared. In this Table, the numerical values are on a mass percent basis.

TABLE 1

| | SOLID | | |
|---|---|---|---|
| | COMPONENT | INK | INK |
| COMPONENT | (%) | 1 | 2 |
| WHITE HOLLOW RESIN | 20.5 | 10 | — |
| PARTICLES SX8782 (D) | | | |
| METAL OXIDE | 15.0 | — | 10 |
| (TITANIUM DIOXIDE) | | | |
| NanoTek (R) Slurry | | | |
| URETHANE RESIN | 30.0 | 5 | 5 |
| GLYCERIN | — | 10 | 10 |
| 1,2-HEXANEDIOL | — | 3 | 3 |
| TRIETHANOLAMINE | — | 0.5 | 0.5 |
| BYK-348 | — | 0.5 | 0.5 |
| ION-EXCHANGED | — | BALANCE | BALANCE |
| WATER | | | |
| TOTAL | — | 100 | 100 |

As the hollow resin particles, a commercially available product, “SX8782(D)” (manufactured by JSR Corporation), shown in Table 1 was used. “SX8782(D)” was an aqueous dispersion product containing particles having an outer diameter of 1.0 μm and an inner diameter of 0.8 μm, and the solid component concentration of this product was 20.5%.

As the metal compound, a commercially available product, “NanoTek (R) Slurry” (manufactured by C. I. Kasei Co., Ltd.) was used. “NanoTek (R) Slurry” was a slurry containing titanium dioxide having an average particle diameter of 36 nm, and the solid component of this slurry was 15.

“BYK-348” (manufactured by BYK Chemie Japan) was a polysiloxane-based surfactant.

As the urethane resin, “WBR-022U” (manufactured by Taisei Fine Chemical Co., Ltd.) was used.

Image Recording (1) Reproduction of Pastel Color by Pigment-Based Color Ink Composition

The formation of a color image was performed by printing using a commercially available ink jet printer (“PX-5500” manufactured by Seiko Epson Corporation) and a commercially available ink set (Epson IC9CL3337 including photo black, matte black, gray, light gray, yellow, cyan, light cyan, magenta, and light magenta).

In addition, the formation of a white layer was performed in such a way that after the white ink composition shown in Table 1 was first filled in a black ink chamber of an exclusive cartridge of an ink jet printer (“PX-G930” manufactured by Seiko Epson Corporation), the ink cartridge thus prepared was fitted in the printer, and then printing was performed.

By the above-described printing method for each color, a sample was obtained by performing color printing (printing condition: paper selection-photo paper gloss, no-color correction, photo-1,440 dpi, and unidirectional printing) on a medium (photo paper <gloss> manufactured by Seiko Epson Corporation) using the ink jet printer “PX-5500”, and the white ink composition was then printed on the sample using the ink jet printer “PX-G930” at a duty of 80% or 100%. Subsequently, the gamut obtained thereby was measured. In this example, the printing was performed so that the mass ratio of the white colorant to the color colorant printed on the recording medium was 200:1 to 1:1. The reason the mass ratio was wide, such as 200 to 1, was that since the usage of the color ink displaying the gamut was not constant, the mass ratio was determined based on the upper limit of the mass ratio which was obtained from a maximum white-ink usage of 200 and a minimum color-ink usage of 1.

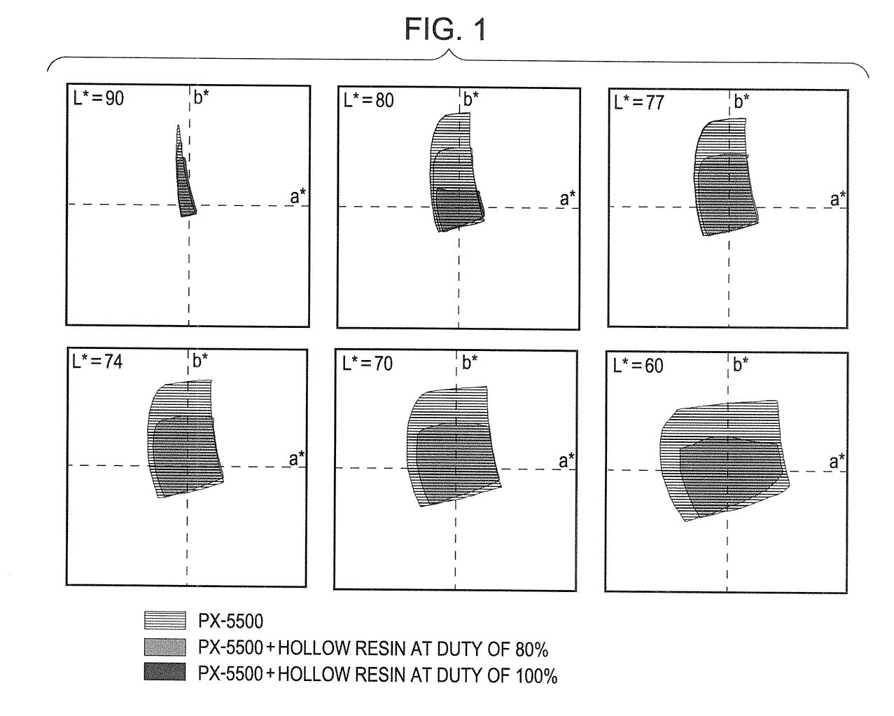

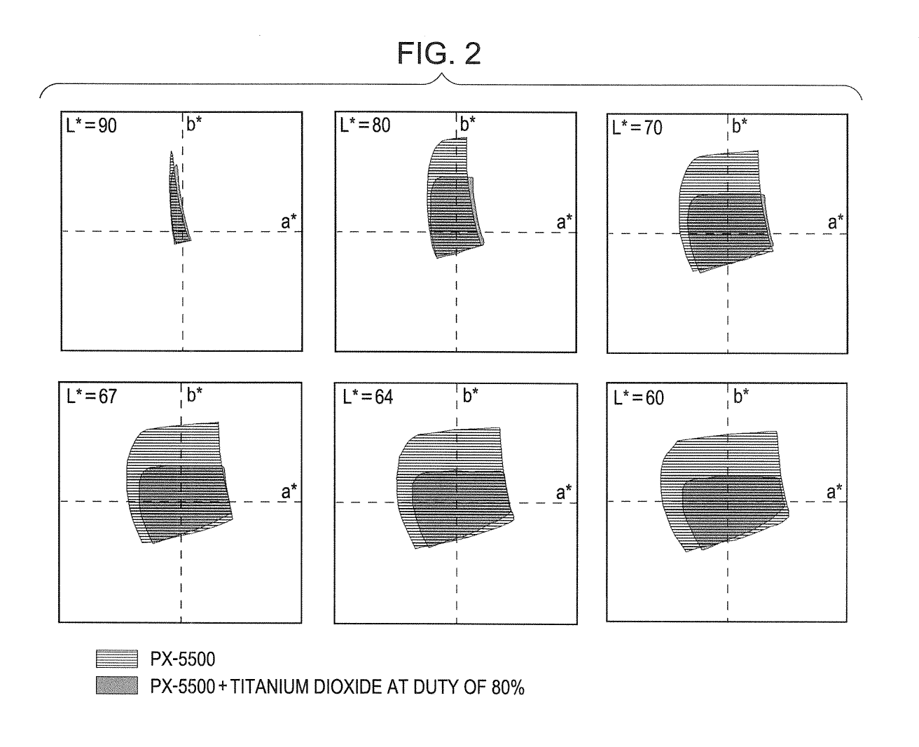

In FIG. 1, the gamut is shown when the ink composition 1 (hollow resin particles) was used as the white ink composition, and in FIG. 2, the gamut is shown when the ink composition 2 (titanium dioxide) was used as the white ink composition.

In this specification, the “duty” is a value calculated in accordance with the following equation.

Duty=100×Actual number of printed dots/(vertical resolution×horizontal resolution)

In the above equation, the “actual number of printed dots” is an actual number of printed dots per unit area, and the “vertical resolution” and the “horizontal resolution” each indicate the resolution per unit area. A duty of 100% indicates the maximum ink mass of a single color per one pixel.

FIG. 1 shows comparisons each between a color reproducing region of a pastel color reproducible by the color compositions (photo black, matte black, gray, light gray, yellow, cyan, light cyan, magenta, and light magenta) under the above printing conditions and a color reproducing region obtained when the white printing (using the hollow resin particles as the white colorant) is performed at a duty of 80% or 100% after the color printing. In this case, in regions in each of which L* was less than 80 shown in FIG. 1, when the duty was 100%, the ink overflowed; hence, a gamut at a duty of 80% is only shown.

In the invention, the CIE/L*a*b* values were measured by Gretag Macbeth Spectroscan and Spectrolino (manufactured by X-Rite Inc.).

From FIG. 1, it is found that in a high luminance region (a region having an L* of 70 or more, and in particular, a gamut at an L* of 80 or 90), a region which cannot be reproduced only by a color composition (composite composed of cyan, magenta, yellow, photo black, light cyan, and light magenta) can be color-reproduced by performing the white printing after the color printing.

FIG. 2 shows comparisons each between a color reproducing region of a pastel color reproducible by the color compositions (photo black, matte black, gray, light gray, yellow, cyan, light cyan, magenta, and light magenta) under the above printing conditions and a color reproducing region obtained when the white printing (using titanium dioxide as the white colorant) is performed at a duty of 80% after the color printing.

From FIG. 2, it is found that in a high luminance region (a region having an L* of 64 or more), a region which cannot be reproduced only by a color composition (composite composed of cyan, magenta, yellow, photo black, light cyan, and light magenta) can be color-reproduced by performing the white printing after the color printing.

Image Recording (2) Reproduction of Pastel Color by Dye-Based Color Ink Composition

The formation of a color image was performed by printing using a commercially available ink jet printer (“EPSON PM-A840” manufactured by Seiko Epson Corporation) and an ink set (Epson IC6CL50 including black, yellow, cyan, light cyan, magenta, and light magenta).

In addition, the formation of a white layer was performed in such a way that after the white ink composition shown in Table 1 was filled in a black ink chamber of an exclusive cartridge of an ink jet printer (“PX-G930” manufactured by Seiko Epson Corporation), the ink cartridge thus prepared was fitted in the printer, and then printing was performed.

By the above-described printing method for each color, a sample was obtained by performing color printing (printing condition: paper selection-photo paper gloss, no-color correction, photo-1,440 dpi, and unidirectional printing) on a medium (photo paper <gloss> manufactured by Seiko Epson Corporation) using the ink jet printer “PM-A840”, and the white ink composition was then printed on the sample using the ink jet printer “PX-G930” at a duty of 80%. Subsequently, the gamut obtained thereby was measured. In this example, the printing was performed so that the mass ratio of the white colorant to the color colorant printed on the recording medium was 200:1 to 1:1. The reason the mass ratio was wide, such as 200 to 1, was that since the usage of the color ink displaying the gamut was not constant, the mass ratio was determined based on the upper limit of the mass ratio which was obtained from a maximum white-ink usage of 200 and a minimum color-ink usage of 1.

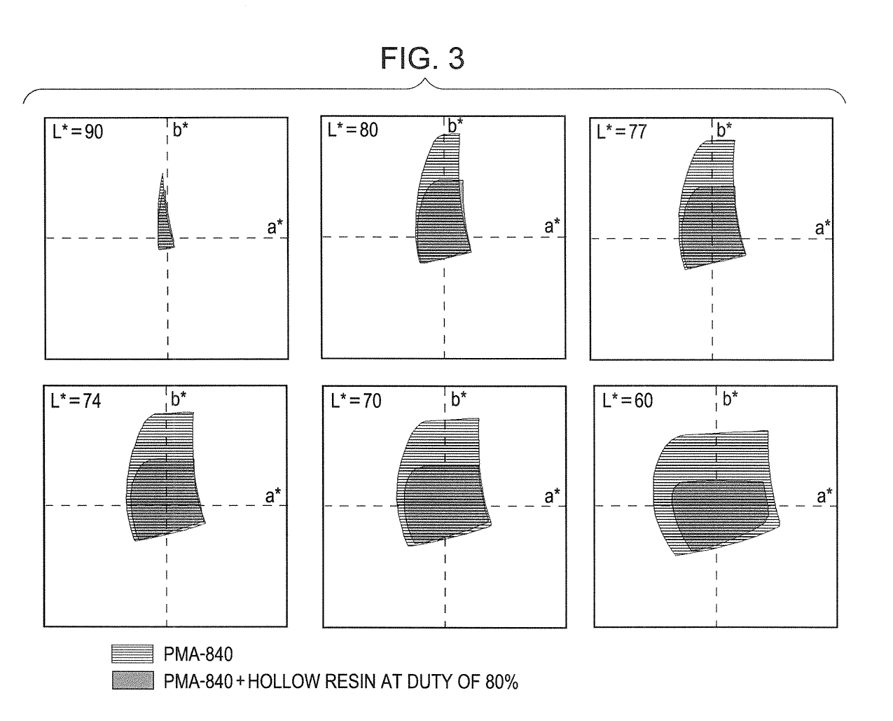

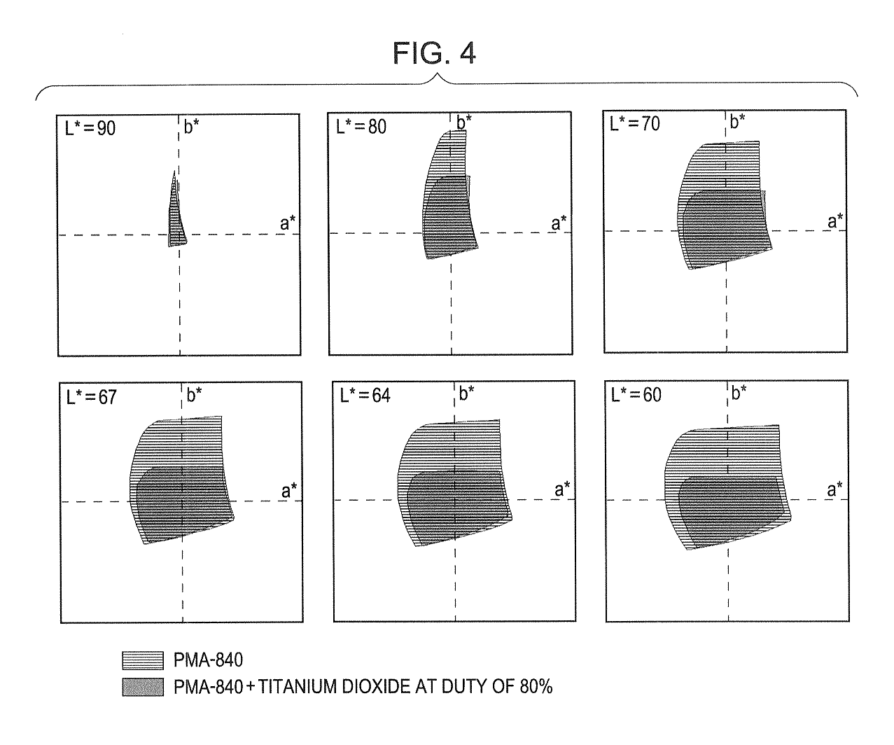

In FIG. 3, the gamut is shown when the ink composition 1 (hollow resin particles) was used as the white ink composition, and in FIG. 4, the gamut is shown when the ink composition 2 (titanium dioxide) was used as the white ink composition.

FIG. 3 shows comparisons each between a color reproducing region of a pastel color reproducible by the color compositions (black, yellow, cyan, light cyan, magenta, and light magenta) under the above printing conditions and a color reproducing region obtained when the white printing (using the hollow resin particles as the white colorant) is performed at a duty of 80% after the color printing.

From FIG. 3, it is found that in a high luminance region (a region having an L* of 74 or more), a region which cannot be reproduced only by a color composition (composite composed of black, yellow, cyan, light cyan, magenta, and light magenta) can be color-reproduced by performing the white printing after the color printing.

FIG. 4 shows comparisons each between a color reproducing region of a pastel color reproducible by the color compositions (black, yellow, cyan, light cyan, magenta, and light magenta) under the above printing conditions and a color reproducing region obtained when the white printing (using titanium dioxide as the white colorant) is performed at a duty of 80% after the color printing.

From FIG. 4, it is found that in a high luminance region (a region having an L* of 67 or more), a region which cannot be reproduced only by a color composition (composite composed of black, yellow, cyan, light cyan, magenta, and light magenta) can be color-reproduced by performing the white printing after the color printing.

Since the hollow resin particles have a higher luminance than that of titanium dioxide, when printing is performed under the same conditions, an L* value at which a pastel color is obtained is high when the hollow resin particles are used. On the other hand, at a relatively low L* value, such as approximately 60 to 70, titanium dioxide is more effective.

L*a*b* Value Numerical Data

Comparison results are shown in the following Table 2 in which in FIGS. 1 to 4, an a* value at an end point portion (an upper right end point of a protruding portion of the white printing region protruding from the color printing region) of the gamut obtained when the white printing is performed after the color printing is compared with an a* value at an end point portion of the gamut obtained only by the color printing while the L* value and the b* value are fixed based on the above end point of the protruding portion. In every case, the gamut of the image sample obtained by performing the white printing after the color printing further extends in a positive a* value direction from that obtained only by the color printing.

TABLE 2

| | | | COLOR PRINTING | | | | | | |
|---|---|---|---|---|---|---|---|---|---|
| | COLOR | | FOLLOWED BY | | | COLOR | | | |
| FIGURE | COLORANT/WHITE | duty | WHITE PRINTING | | | PRINTING ONLY | | | |
| NUMBER | COLORANT | (%) | L* | a₁* | b* | L* | a₂* | b* | Δa₁* − a₂* |
| FIG. 1 | COLOR | 100 | 90 | −3.2 | 40.0 | 90 | −5.2 | 40.0 | 2.0 |
| | PIGMENT/HOLLOW | 100 | 80 | 16.8 | 12.8 | 80 | 14.4 | 12.8 | 2.4 |
| | RESIN PARTICLES | 80 | 90 | −6.0 | 53.2 | 90 | −6.8 | 53.2 | 0.8 |
| | | 80 | 80 | 10.8 | 49.2 | 80 | 9.2 | 49.2 | 1.6 |
| | | 80 | 70 | 28.0 | 36.0 | 70 | 27.6 | 36.0 | 0.4 |
| FIG. 2 | COLOR | 80 | 90 | −4.0 | 56.0 | 90 | −6.4 | 56.0 | 2.4 |
| | PIGMENT/TITANIUM | 80 | 80 | 15.2 | 47.0 | 80 | 10.8 | 47.0 | 4.4 |
| | DIOXIDE | 80 | 70 | 32.0 | 32.0 | 70 | 28.4 | 32.0 | 3.6 |
| | | 80 | 64 | 40.0 | 24.0 | 64 | 39.3 | 24.0 | 0.7 |
| FIG. 3 | COLOR DYE/HOLLOW | 80 | 90 | −1.6 | 40.0 | 90 | −3.2 | 40.0 | 1.6 |
| | RESIN PARTICLES | 80 | 80 | 16.4 | 46.8 | 80 | 12.0 | 46.8 | 4.4 |
| | | 80 | 74 | 23.4 | 39.3 | 74 | 22.8 | 39.3 | 0.6 |
| FIG. 4 | COLOR | 80 | 90 | −1.2 | 46.6 | 90 | −3.2 | 46.6 | 2.0 |
| | DYE/TITANIUM | 80 | 80 | 16.0 | 46.4 | 80 | 12.0 | 46.4 | 4.0 |
| | DIOXIDE | 80 | 70 | 33.6 | 32.8 | 70 | 29.6 | 32.8 | 4.0 |
| | | 80 | 67 | 33.9 | 26.1 | 67 | 30.3 | 26.1 | 3.6 |

1. An image recording method comprising:
forming a color image on a recording medium using a color ink composition containing a color colorant; and
forming a white layer on the color image using a white ink composition containing a white colorant,
wherein the white layer is formed on the color image so that an equivalent ratio of the white colorant to the color colorant is set to 1 to 1,000:1 to form a pastel color image.

2. The image recording method according to claim 1,
wherein in the CIE/L*a*b* color space, the pastel color is a color in which L*≧60, −50≦a*≦50, and −50≦b*≦50 hold.

3. The image recording method according to claim 1,
wherein the white colorant is at least one selected from the group consisting of a metal compound and hollow resin particles.

4. The image recording method according to claim 1,
wherein the color colorant is a pigment colorant or a dye colorant.

5. The image recording method according to claim 1,
wherein the image recording method is performed by an ink jet recording system.

6. A recording material obtained by the image recording method according to claim 1.

7. An image recording apparatus using the image recording method according to claim 1.
